(19) United States
(12) Patent Application Publication
(10) Pub. No.: US 2019/0222810 A1
(43) Pub. Date: Jul. 18, 2019

(54) INSPECTION DEVICE

(71) Applicant: DENSO CORPORATION, Kariya-city (JP)

(72) Inventors: Masaru HORIGUCHI, Kariya-city (JP); Kohei NAKAMURA, Kariya-city (JP); Hiroyuki IWATSUKI, Kariya-city (JP); Katsuhiro MIYAGAKI, Kariya-city (JP); Shinji KATO, Kariya-city (JP)

(21) Appl. No.: 16/362,783

(22) Filed: Mar. 25, 2019

Related U.S. Application Data
(63) Continuation of application No. PCT/JP2017/034893, filed on Sep. 27, 2017.

(30) Foreign Application Priority Data
Sep. 28, 2016 (JP) 2016-190099

(51) Int. Cl. H04N 7/18; G06K 9/00; H04N 5/232

(52) U.S. Cl. CPC H04N 7/188; G06K 9/00375; G06K 9/00664; G06T 7/001; G06T 2207/30164; G06T 2207/30204; H04N 5/23218

(57) ABSTRACT

An inspection device includes a trigger detection unit that detects a trigger of visual confirmation work, and a camera control unit that controls a wearable camera worn by a worker to take an image when the trigger of the visual confirmation work is detected by the trigger detection unit.

### CROSS REFERENCE TO RELATED APPLICATIONS

The present application is a continuation application of International Patent Application No. PCT/JP2017/034893 filed on Sep. 27, 2017, which designated the United States and claims the benefit of priority from Japanese Patent Application No. 2016-190099 filed on Sep. 28, 2016. The entire disclosures of the above applications are incorporated herein by reference.

### TECHNICAL FIELD

The present disclosure relates to an inspection device.

### BACKGROUND

In the manufacturing process of a product, the quality of an object to be inspected such as a product at an intermediate stage (hereinafter referred to as “workpiece”) or a finished product may be visually inspected by a worker. In this case, a wearable camera may support the inspection work by capturing images.

### SUMMARY

An inspection device of the present disclosure may include a trigger detection unit that detects a trigger of visual confirmation work, and a camera control unit that controls a wearable camera worn by a worker to take an image when the trigger of the visual confirmation work is detected by the trigger detection unit.

### BRIEF DESCRIPTION OF DRAWINGS

FIG. 1 is a diagram schematically showing a schematic configuration of an inspection device according to a first embodiment and an example of an inspection work to which an inspection device is applied.

FIG. 2 is a block diagram showing a configuration of an inspection device according to the first embodiment.

FIG. 3 is a diagram showing functions relating to automatic recording for visual confirmation work in the inspection device according to a first embodiment.

FIG. 4 is a flowchart of automatic recording processing for visual confirmation work.

FIG. 5 is a diagram showing functions relating to automatic recording for visual confirmation work in the inspection device according to a second embodiment.

FIG. 6 is a figure for explaining a trigger detection method of visual confirmation work in the inspection device according to a third embodiment.

FIG. 7 is a figure for explaining a trigger detection method of visual confirmation work in the inspection device according to a fourth embodiment.

### DETAILED DESCRIPTION

Hereinafter, the present embodiments will be described with reference to the attached drawings. In order to facilitate the ease of understanding, the same reference numerals are attached to the same constituent elements in each drawing where possible, and redundant explanations are omitted.

### First Embodiment

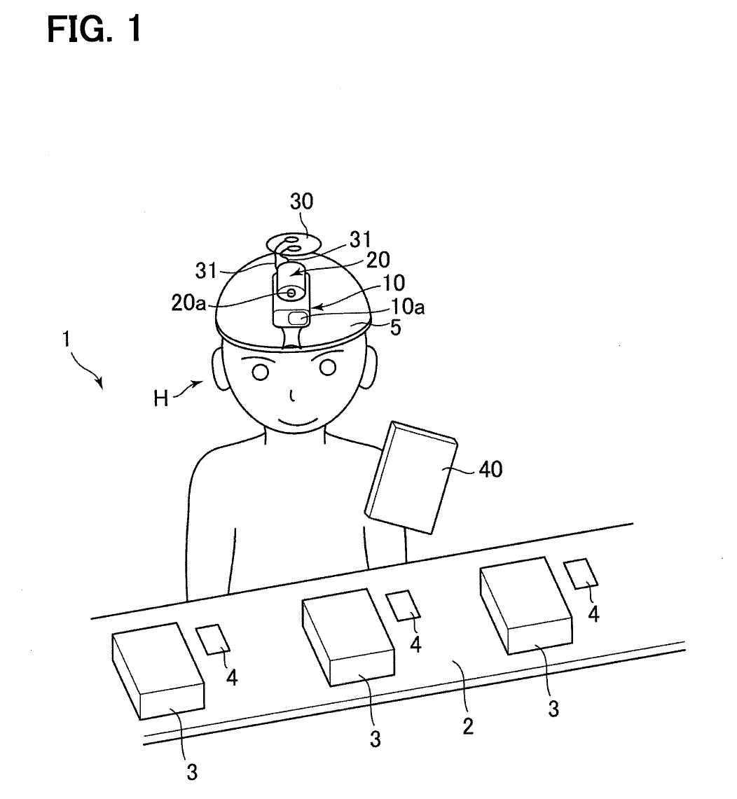

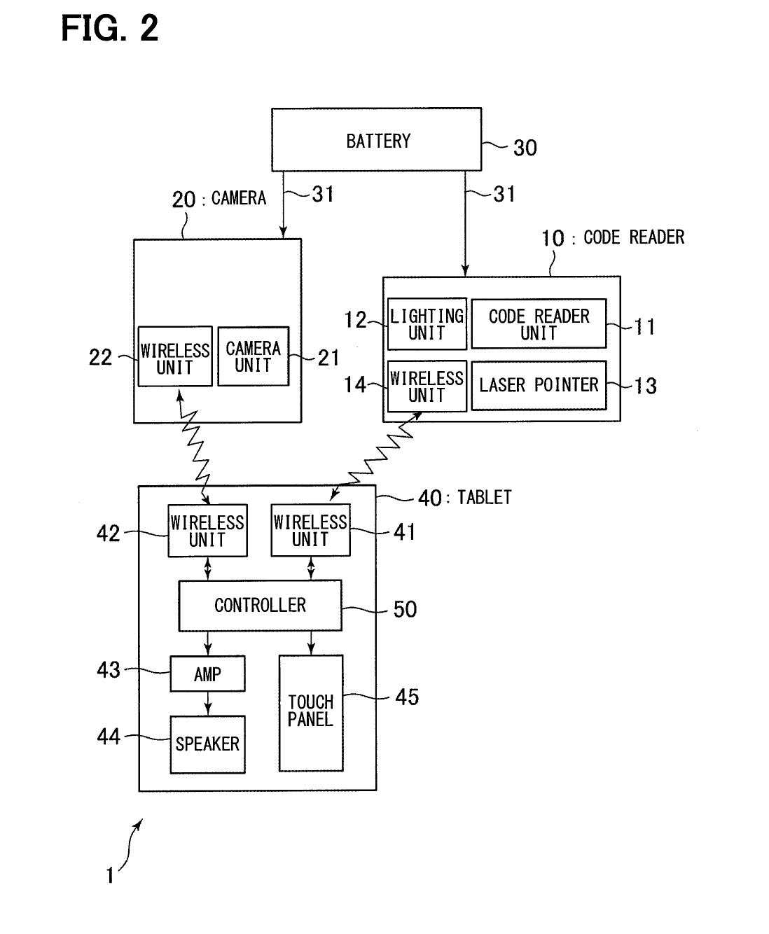

A first embodiment will be described hereafter with reference to FIGS. 1 to 4. First, with reference to FIG. 1 and FIG. 2, an example of an inspection work to which an inspection device 1 according to the first embodiment is applied and a schematic configuration of the inspection device 1 will be described.

The inspection device 1 according to the first embodiment is used in the manufacturing process of a product such as a heat exchanger. Specifically, the inspection device 1 is used in an inspection work for judging whether or not an object to be inspected, such as the workpiece 3 at an intermediate manufacturing stage or a finished product, are good products. As an example such inspection work, for example, the configuration shown in FIG. 1 is provided.

A worker H of the inspection work inspects whether or not the workpieces 3 sequentially conveyed by a conveyor 2 are good. The conveyor 2 carries a plurality of sets of workpieces 3 and signs 4 and conveys these sets so that each set is positioned in front of the worker H in sequence. The signboard 4 is arranged near its corresponding workpiece 3, and a code indicating the type of the workpiece 3 is displayed on that signboard 4.

The worker H can perform the above-described inspection work using the inspection device 1 of the present embodiment. As shown in FIGS. 1 and 2, the inspection device 1 includes a code reader 10, a wearable camera 20, a battery 30, and a tablet 40.

As shown in FIG. 2, the code reader 10 includes a code reader unit 11, a lighting unit 12, a laser pointer unit 13, and a wireless unit 14.

The code reader unit 11 a well known optical code reader including a light source that irradiates light. Light is emitted from the light source through lens 10a, reflected by the signboard 4, and received through the lens 10a. The code reader unit 11 reads this reflected light to read codes. Here, the signboard 4 of the present embodiment is a display board on which a code is displayed. The code is an identification indicator indicating the type of the workpiece 3. Various codes, such as a QR code (registered trademark) or a bar code, may be used as the code.

The lighting unit 12 illuminates the workpiece 3 and its surroundings through the lens 10a.

The laser pointer unit 13 irradiates a laser beam as a pointer through the lens 10a. Thus, the laser pointer unit 13 assists the worker H to recognize a target reading area in which the code reader unit 11 reads codes. In the present embodiment, the region irradiated with the laser beam by the laser pointer unit 13 is set to coincide with the target reading area of the code reader unit 11.

The wireless unit 14 is composed of an antenna, a wireless circuit, and the like, and wirelessly communicates with the wireless unit 41 of the tablet 40.

The wearable camera 20 is a compact camera which is attached to a body or the like and is intended to capture images in a hands-free manner. As shown in FIG. 2, the wearable camera 20 includes a camera unit 21 and a wireless unit 22. The camera unit 21 captures images of the workpiece 3 as an target imaging object using the light received via lens 20a. The wireless unit 22 is composed of an antenna, a wireless circuit, and the like, and wirelessly communicates with the wireless unit 42 of the tablet 40.

The battery 30 is a secondary battery that supplies direct current power to the code reader 10 and the camera 20 via a harness 31 or the like.

In the present embodiment, as shown in FIG. 1, the code reader 10, the wearable camera 20, and the battery 30 are mounted on a hat 5 to be work by the worker H. Further, the code reader 10 and the wearable camera 20 are installed on the hat 5 of the worker H so that the lens 10a of the code reader 10 and the lens 20a of the wearable camera 20 are disposed facing the front of the worker H.

The tablet 40 is a portable terminal configured to be carried by the worker H. As shown in FIG. 2, the tablet 40 includes wireless units 41 and 42, an amplifier 43, a speaker 44, a touch panel 45, and a controller 50.

The wireless units 41 and 42 are composed of an antenna, a wireless circuit, and the like. The wireless unit 41 wirelessly communicates with the wireless unit 14 of the code reader 10. The wireless unit 42 wirelessly communicates with the wireless unit 22 of the wearable camera 20. In the present embodiment, various types of short range wireless communications may be used for wireless communication between the wireless units. Bluetooth (registered trademark) or Wi-Fi (registered trademark) can be used as the short-range wireless communication.

The amplifier 43 amplifies the voltage of the analog signal output from the controller 50 and outputs an amplified signal. The speaker 44 converts the amplified signal output from the amplifier 43 into sound and outputs the sound. The touch panel 45 is a display device combining a transparent key input operation unit and a display panel.

The controller 50 is a device that controls the operation of each part of the inspection device 1 related to the above-described inspection work. The controller 50 is physically a microcontroller composed of a CPU, a memory, digital-analog conversion circuits, and the like. The controller 50 executes an inspection process in accordance with a computer program stored in advance in the memory. The inspection process is a determination process of determining whether or not the workpiece 3 is a non-defective product based on the code acquired from the code reader 10 and the captured image acquired by the wearable camera 20.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

By using the inspection device 1 configured in this way, the a standard work of the inspection process (hereinafter referred to as “standard work) of the workpiece 3 performed by the worker H may be, for example, the following procedure.

First, the worker H directs their head to face the signboard 4, so that the code reader 10 attached to the hat 5 reads the code from the signboard 4. Next, the head is directed to face the workpiece 3, and the wearable camera 20 attached to the hat 5 likewise captures the image of the workpiece 3 to acquire the captured image. That is, using the code reader 10 reading the code from the signboard 4 as a trigger, the wearable camera 20 acquires the captured image of the workpiece 3. The tablet 40 receives the code from the code reader 10 via wireless communication and receives the captured image from the wearable camera 20.

The controller 50 in the tablet 40 selects the reference image corresponding to the received code from the plurality of types of reference images stored in advance in the memory as described above. The controller 50 compares the captured image of the workpiece 3 with the reference image to determine whether or not the workpiece 3 is a non-defective product. In addition, the controller 50 notifies the worker H of the result of pass/fail determination of the workpiece 3 via sound information or visual information using the speaker 44 of the tablet 40 or the touch panel 45 of the tablet 40.

The worker H continues to the next work based on the information of the determination result outputted from the tablet 40. For example, if it is determined that the workpiece 3 is a non-defective product, the next workpiece 3 on the conveyor 2 is inspected.

The inspection device 1 configured as described above is carried by the worker H as a wearable device so that both hands of the worker H are free. With the above configuration, the inspection device 1 can automatically perform the inspection work for the inspection object without requiring any operation using the hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

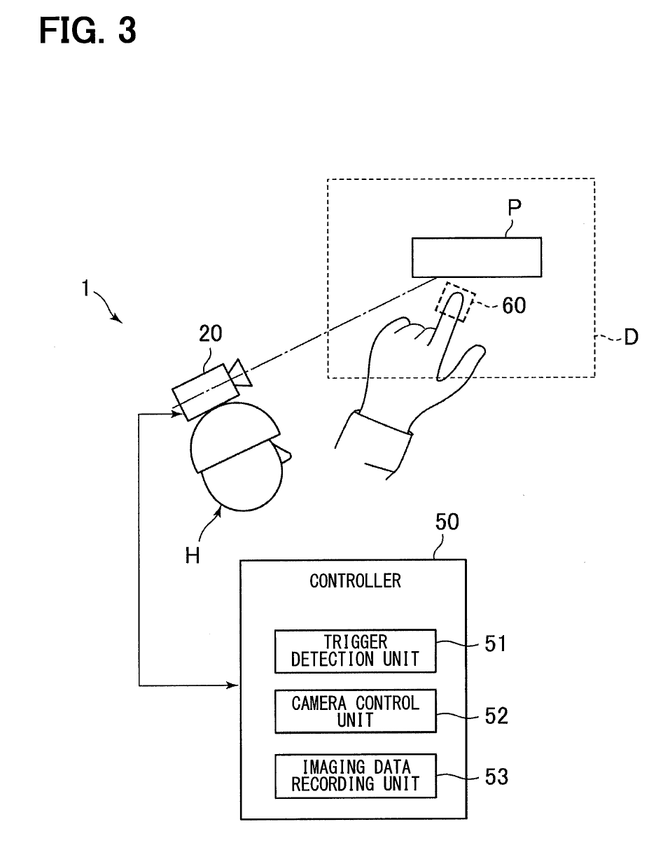

Here, as one kind of the above described inspection work, there is visual confirmation work in which a worker H visually confirms a target, such as for maintenance inspection of instruments. During such visual confirmation work, in which an image including a visual confirmation target (hereinafter referred to as an “imaging object P”) is automatically recorded as a work record by using the wearable camera 20 attached to the worker H, there is a need to reduce work burden on the worker H. Therefore, in the present embodiment, by using the above-described inspection device 1, it is possible to configure the wearable camera 20 attached to the worker H to automatically capture images during the visual confirmation when a trigger related to visual confirmation work is detected. In particular, in the present embodiment, as shown in FIG. 3, the detection of a fingertip 60 of the worker H in the screen D of the wearable camera 20 is used as a trigger of the visual confirmation work. In FIG. 3, the frame of the screen D imaged by the wearable camera 20 is virtually shown as a dotted line around the imaging object P and the fingertip 60.

As shown in FIG. 3, as functions relating to automatic recording for such visual confirmation work, the controller 50 of the inspection device 1 includes a trigger detection unit 51, a camera control unit 52, and an imaging data recording unit 53.

The trigger detection unit 51 detects a trigger relating to visual confirmation work. More specifically, the trigger detection unit 51 detects a trigger based on information included in the screen D imaged by the wearable camera 20. In particular, in the first embodiment, the trigger detection unit 51 uses the detection of the fingertip 60 of the worker H in the screen D of the wearable camera 20 as a trigger.

The camera control unit 52 controls the operation of the wearable camera 20. Here, the camera control unit 52 controls the wearable camera 20 to capture images when a trigger (the fingertip 60) of the visual confirmation work is detected by the trigger detection unit 51. Further, based on the trigger detected by the trigger detection unit 51, the camera control unit 52 controls the wearable camera to capture images while focusing on the imaging object P, which is the visual confirmation work target, in the screen D of the wearable camera 20.

The imaging data recording unit 53 records the image data of the visual confirmation work captured by the wearable camera 20. The image data can be in any form, for example, a still image including the imaging object P which is the target of the visual confirmation work, or video data captured during the visual confirmation work.

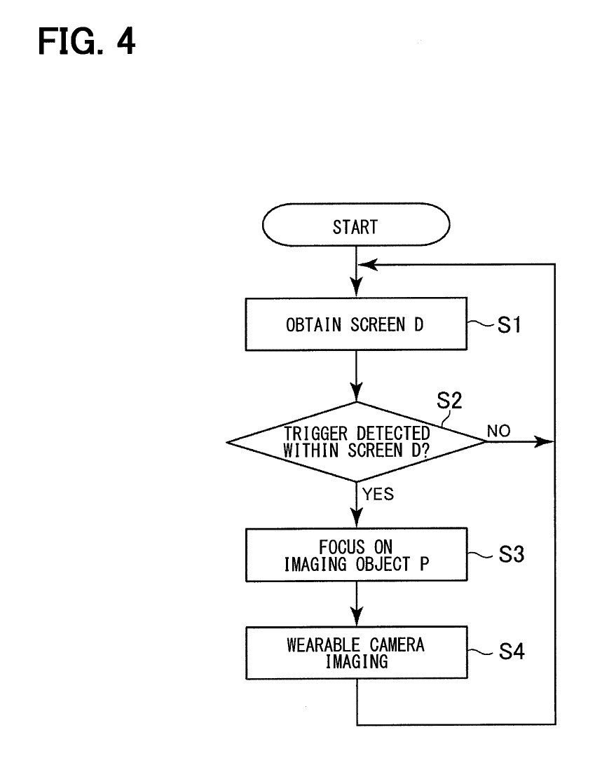

With reference to FIG. 4, the procedure of automatic recording processing for the visual confirmation work will be described. The processing of the flowchart shown in FIG. 4 may be executed, for example, at predetermined intervals by the controller 50 of the inspection device 1.

In step S1, the screen D of the wearable camera 20 is acquired by the trigger detection unit 51. The wearable camera 20 continuously outputs the captured image to the tablet 40 during operation of the inspection device 1 at least while the visual confirmation work is being performed. In this manner, the captured image is input to the trigger detection unit 51, which acquires the screen D under arbitrary conditions. When the process of step S1 is completed, the process moves to step S2.

In step S2, the trigger detection unit 51 determines whether or not a trigger is detected within the screen D acquired in step S1. In particular, the trigger detection unit 51 uses the detection of the fingertip 60 of the worker H in the screen D of the wearable camera 20 as a trigger. Typically, during visual confirmation work, the worker H turns to the visual confirmation target (imaging object P) at the time of visual confirmation, and performs the visual confirmation in accordance with industrial safety guidelines by pointing at the visual confirmation target. In other words, during a typical visual confirmation, the fingertip 60 of the worker H would be positioned in the vicinity of the imaging object P anyway. In the present embodiment, using such required operation in visual confirmation work, the detection/non-detection of the trigger is determined by the presence or absence of the fingertip 60 in the screen D. As a result of the determination in step S2, when the fingertip 60 of the worker H as the trigger is detected in the screen D (YES in step S2), the trigger detection unit 51 outputs the determination result indicating that the trigger has been detected to the camera control unit 52, and proceeds to step S3. Otherwise (NO in step S2), the process returns to step 51, and steps 51 and S2 are repeated until a trigger is detected.

In step S3, in response to the determination that the trigger is detected in the screen D in step S2, the camera control unit 52 performs a control to focus on the imaging object P. For example, with the trigger fingertip 60 as a reference, the camera control unit 52 may control the focal position of the wearable camera 20 so as to focus on the imaging object P which is farther than the fingertip 60. Thereby, it is possible to prevent the focal point from being focused on the fingertip 60 located on the near side of the imaging target. When the process of step S3 is completed, the process moves to step S4.

In step S4, the camera control unit 52 executes imaging of the wearable camera 20. The camera control unit 52 records the imaging data of the visual confirmation work captured by the wearable camera 20 in the imaging data recording unit 53. Further, at this time, the camera control unit 52 may control the imaging region in accordance with the size of the imaging object P. Upon completion of the process of step S4, the process returns to step 51 and the entire series of steps is repeated.

Next, effects of the inspection device 1 according to the first embodiment will be described. In the inspection device 1 of the first embodiment, when the trigger detection unit 51 of the controller 50 detects the trigger (the fingertip 60) of the visual confirmation work, the camera control unit 52 is able to control the wearable camera 20 to capture images. As a result, image data can be automatically recorded with the worker H performing visual confirmation work in a typical manner. In other words, the worker H does not have to perform any special steps during the visual confirmation work. As a result, it is possible to easily capture images automatically with the wearable camera 20 during visual confirmation work.

Further, according to the inspection device 1 of the first embodiment, the trigger detection unit 51 detects a trigger based on information (the fingertip 60) included in the screen D imaged by the wearable camera 20. Then, based on the trigger detected by the trigger detection unit 51, the camera control unit 52 controls the wearable camera to capture images while focusing on the imaging object P, which is the visual confirmation work target, in the screen D of the wearable camera 20.

Conventionally, during a standard inspection in which the distance between the camera and the imaging target is fixed, high quality images may be captured in focus as long as timing is correct. However, when capturing images using the wearable camera 20 during visual confirmation, the distance and angle between the wearable camera 20 and the imaging object P change every time the operation is performed. As a result, in order to capture high quality images, it is necessary to adjust focus every time the operation is performed. In contrast, with the inspection device 1 according to the first embodiment, due to the above described configuration, even if the distance and angle between the camera 20 and the imaging object P change every time the visual confirmation work is performed, the imaging is performed while automatically focusing based on the trigger (the fingertip 60) in the screen D. Accordingly, even if the wearable camera 20 is used to captured images during visual confirmation work in which the distance and angle to the imaging object are changed each time, it is possible to easily capture high quality images without the worker H having to perform any special operations for focus adjustment.

Further, according to the inspection device 1 of the first embodiment, the trigger detection unit 51 uses the detection of the fingertip 60 of the worker H in the screen D of the wearable camera 20 as a trigger. Due to this, the trigger is detected using actions that the worker H would normally perform as part of the visual confirmation work, i.e., physically pointing a finger at the visual confirmation target (part of the so-called “pointing and calling” industrial safety method). As a result, it is possible to perform the automatic imaging during the visual confirmation without causing the worker H to feel any burden.

### Second Embodiment

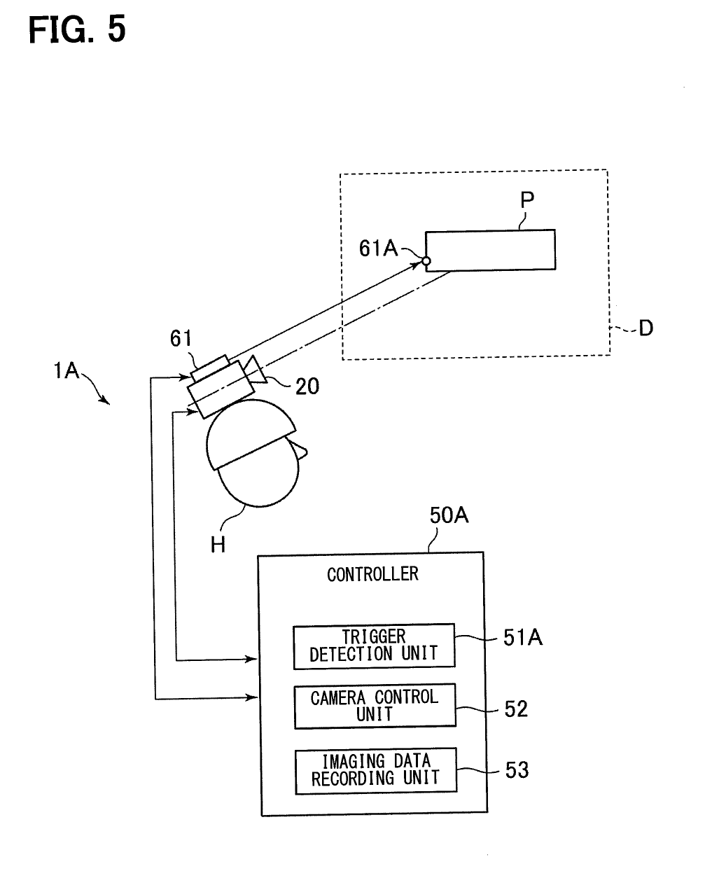

The second embodiment will be described with reference to FIG. 5. The inspection device 1A according to the second embodiment is different from the inspection device 1 of the first embodiment with respect to the information used as the trigger of the visual confirmation work.

As shown in FIG. 5, the inspection device 1A of the second embodiment includes a laser sensor 61. The laser sensor 61 can measure the distance to an object irradiated with the laser beam. In the inspection device 1A according to the second embodiment, a trigger detection unit 51A of a controller 50A detects a trigger as when a light point 61A of the laser sensor 61 does not move for a predetermined time within the screen D of the wearable camera 20. In the case of the configuration of the second embodiment, in step S2 of FIG. 4, the above process of the trigger detection unit 51A is used to determine whether or not a trigger is detected in the screen D.

According to this configuration as well, the trigger is detected using actions that the worker H would normally perform as part of the visual confirmation work, i.e., looking at the visual confirmation target (the imaging object P) for a predetermined amount of time. As a result, it is possible to perform the automatic imaging during the visual confirmation without causing the worker H to feel any burden.

### Third Embodiment

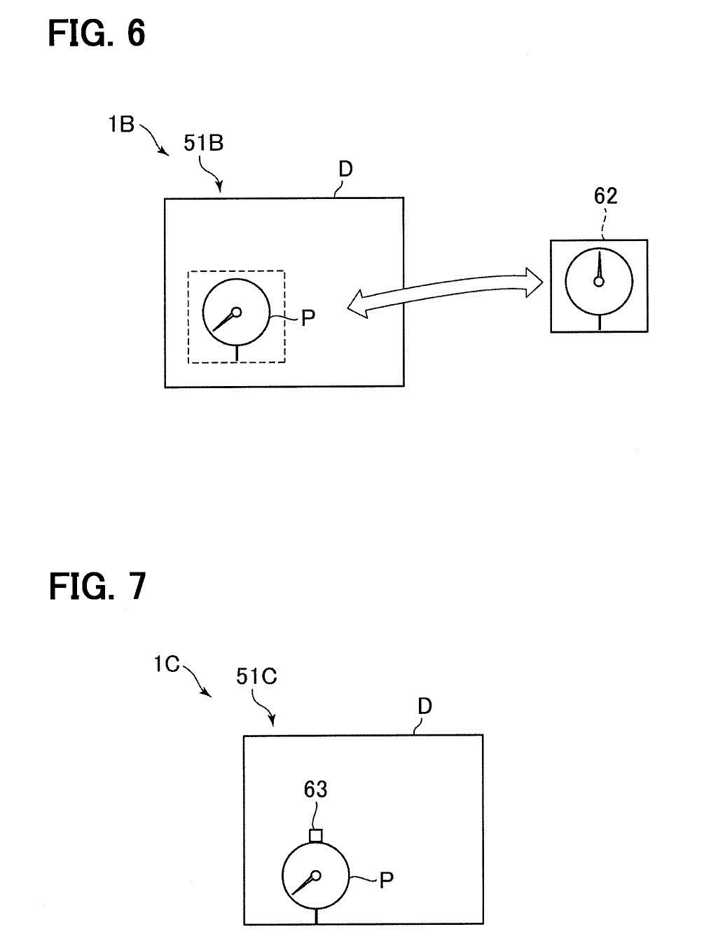

The third embodiment will be described with reference to FIG. 6. The inspection device 1B according to the third embodiment is different from the inspection device 1 of the first embodiment with respect to the information used as the trigger of the visual confirmation work.

As shown in FIG. 6, in the inspection device 1B of the third embodiment, a trigger detection unit 51B includes a template image 62 related to the imaging object P which is the target of the visual confirmation work. Then, the trigger detection unit 51B detects the imaging object P within the screen D of the wearable camera 20 based on the template image 62. The trigger detect unit 51B uses this detection of the imaging object P as a trigger. In the case of the configuration of the third embodiment, in step S2 of FIG. 4, the above process of the trigger detection unit 51B is used to determine whether or not a trigger is detected in the screen D.

According to this configuration as well, the trigger is detected using actions that the worker H would normally perform as part of the visual confirmation work, i.e., looking at the visual confirmation target (the imaging object P). As a result, it is possible to perform the automatic imaging during the visual confirmation without causing the worker H to feel any burden.

### Fourth Embodiment

The fourth embodiment will be described with reference to FIG. 7. The inspection device 1C according to the fourth embodiment is different from the inspection device 1 of the first embodiment with respect to the information used as the trigger of the visual confirmation work.

As shown in FIG. 7, in the inspection device 1B of the third embodiment, a trigger detection unit 51C detects a marker 63 attached to the imaging object P, which is the visual confirmation work target, within the screen D of the wearable camera 20. The trigger detect unit 51B uses this detection of the marker 63 as a trigger. In the case of the configuration of the fourth embodiment, in step S2 of FIG. 4, the above process of the trigger detection unit 51C is used to determine whether or not a trigger is detected in the screen D.

According to this configuration as well, the trigger is detected using actions that the worker H would normally perform as part of the visual confirmation work, i.e., looking at the visual confirmation target (the imaging object P). As a result, it is possible to perform the automatic imaging during the visual confirmation without causing the worker H to feel any burden.

The present embodiments have been described with reference to specific examples above. However, the present disclosure is not limited to those specific examples. Those specific examples subjected to an appropriate design change by those skilled in the art are also encompassed in the scope of the present disclosure as long as the changed examples have the features of the present disclosure. Each element included in each of the specific examples described above and the placement, condition, shape, and the like of each element are not limited to those illustrated, and can be changed as appropriate. The combinations of elements included in each of the above described specific examples can be appropriately modified as long as no technical inconsistency occurs.

The details of the inspection work to which the inspection device 1, 1A, 1B, 1C according to the embodiments described with reference to FIG. 1 and FIG. 2 are applied and the specific configurations of the inspection device 1, 1A, 1B, 1C are merely examples and are not limited to those shown in FIGS. 1 and 2. For example, in the above described embodiments, the inspection object to be inspected for pass/fail determination is the workpiece 3 which is the product at an intermediate stage of production, but completed products can also be included.

In the above embodiments, the trigger detection units 51, 51A, 51B, 51C, the camera control unit 52, and the imaging data recording unit 53 are installed in the tablet 40 and carried by the worker H of the inspection work. However, this is an exemplary embodiment, and at least a part of these constituent elements may be provided at another place apart from the work area of the worker H. As such a configuration, for example, a configuration in which these constituent elements are mounted in a computer apparatus installed at a remote location is contemplated.

In the above described embodiments, the wearable camera 20 is installed on the head of the worker H. However, the installation position of the wearable camera 20 is not limited to the head, but may be an arm portion, a hand portion, a midsection, or any arbitrary part of the body of the worker H.

1. An inspection device for use by a worker for visual confirmation work, comprising:
a trigger detection unit that detects a trigger of the visual confirmation work; and
a camera control unit that controls a wearable camera worn by the worker to take an image when the trigger of the visual confirmation work is detected by the trigger detection unit.

2. The inspection device according to claim 1, wherein
the trigger detection unit detects the trigger based on information included in a screen imaged by the wearable camera, and
the camera control unit, controls, based on the trigger detected by the trigger detection unit, the wearable camera to capture images while focusing on an imaging object, which is the visual confirmation work target, in the screen of the wearable camera.

3. The inspection device according to claim 2, wherein
the trigger detection unit uses the detection of a fingertip of the worker H in the screen of the wearable camera as the trigger.

4. The inspection device according to claim 2, wherein
the trigger detection unit uses a light point of a laser sensor not moving for a predetermined time within the screen of the wearable camera as the trigger.

5. The inspection device according to claim 2, wherein
the trigger detection unit includes a template image related to the imaging object which is the visual confirmation work target, and uses the detection of the imaging object within the screen of the wearable camera based on the template image as the trigger.

6. The inspection device according to claim 2, wherein
the trigger detection unit uses the detection of a marker attached to the imaging object, which is the visual confirmation work target, within the screen of the wearable camera as the trigger.

7. An inspection device for use by a worker for visual confirmation work, comprising:
a wearable camera configured to be attached to the worker; and
a processor coupled to the wearable camera, the processor being programmed to:
receive screen data from the wearable camera,
analyze the screen data to detect a trigger indicating that a visual confirmation target exists within the screen of the wearable camera, and
upon detecting the trigger, control the wearable camera to capture an image.
